(19) United States
(12) Patent Application Publication
(10) Pub. No.: US 2016/0238265 A1
(43) Pub. Date: Aug. 18, 2016

(54) PEAK LOAD SHIFTING VIA THERMAL ENERGY STORAGE USING A THERMOSYPHON

(71) Applicant: Arizona Board of Regents on behalf of Arizona State University, Scottsdale, AZ (US)

(72) Inventors: Jonathan Sherbeck, Tempe, AZ (US); Benjamin Ruddell, Queen Creek, AZ (US)

(21) Appl. No.: 15/138,438

(22) Filed: Apr. 26, 2016

Related U.S. Application Data
(63) Continuation of application No. PCT/US2014/062609, filed on Oct. 28, 2014.
(60) Provisional application No. 61/897,029, filed on Oct. 29, 2013.

(51) Int. Cl. F24F 5/00; F16K 31/04; F25B 49/02; F16K 11/07; F25B 41/04; F25B 5/02

(52) U.S. Cl. CPC F24F 5/0017; F25B 41/043; F25B 5/02; F25B 49/02; F24F 5/001; F16K 11/0716; F16K 31/041; F25B 2600/2501; F25B 2400/24; F25B 2400/0401; F25B 2400/0403; F25B 2400/0409

(57) ABSTRACT

Systems and methods for thermal energy storage are disclosed. A thermal energy storage unit and an evaporator coil may form a thermosyphon. In an energy consumption mode, refrigerant may be directed from a compressor, through a condenser coil, to an evaporator coil via a first 3-way valve, and back to the compressor via a second 3-way valve. In an energy storage mode, refrigerant may be directed from the compressor, through the condenser coil, to a thermal energy storage unit via the first 3-way valve, and back to the compressor via the second 3-way valve. In an energy discharge mode, refrigerant may be directed from the thermal energy storage unit to the evaporator coil via the second 3-way valve, and back to the thermal energy storage unit via a vapor line.

### CROSS-REFERENCE TO RELATED APPLICATIONS

This application is a continuation of PCT Application No. PCT/US2014/062609 filed on Oct. 28, 2014 and entitled “PEAK LOAD SHIFTING VIA THERMAL ENERGY STORAGE USING A THERMOSYPHON”. PCT Application No. PCT/US2014/062609 claims priority to, and the benefit of, U.S. Provisional Application Ser. No. 61/897,029 filed on Oct. 29, 2013 and entitled “PEAK LOAD SHIFTING VIA THERMAL ENERGY STORAGE USING ICE WITH A THERMOSYPHON FOR DISCHARGE.” Both of the above applications are hereby incorporated by reference in their entirety.

### TECHNICAL FIELD

The present disclosure relates to heating and cooling systems, and specifically to heating and cooling systems which use stored thermal energy.

### BACKGROUND

Peak summertime afternoon electrical loads are of great concern to electrical utilities, because summertime peak loads are responsible for large capital generation costs and strain on the power transmission and distribution grids. The peak loads are also of concern to cost-conscious customers, because these afternoon times of day often have per-kW-hour costs several times higher than off-peak costs. Air Conditioning (AC) units, and particularly residential units, are a major source both of the afternoon summertime peak loads on the power grid, and of growth in these loads. Because small AC units are typically the single largest source of power grid peak loads in hot regions, and because they represent a point of union between the financial interests of both power utilities and power customers, it is in the interest of all parties that a cost-effective “peak shaving” system be developed, for example for single family residences, to effectively shift peak loads to the morning and nighttime hours. Ideally, this system would be (i) a “bolt-on” solution that is easily added as a retrofit option without tearing into the structure, (ii) cost-effective, and (iii) scalable to larger residences and commercial operations. Accordingly, improved cooling systems remain desirable.

### SUMMARY

Systems and methods for heating and cooling utilizing stored thermal energy are disclosed. In an exemplary embodiment, a cooling system comprises a compressor, a condenser coil, an evaporator coil, and a thermal energy storage unit. The cooling system further comprises a first 3-way valve positioned between the condenser coil and the evaporator coil, and a second 3-way valve positioned between the evaporator coil and the compressor. The thermal energy storage unit and the evaporator coil form a thermosyphon.

In another exemplary embodiment, a method of providing cooling comprises operating a cooling system in an energy consumption mode, operating the cooling system in an energy storage mode, and operating the cooling system in an energy discharge mode.

In another exemplary embodiment, a thermal energy storage system comprises a thermal energy storage unit, a first 3-way valve configured to be inserted between a condenser coil and an evaporator coil in an existing cooling system, and a second 3-way valve configured to be inserted between the evaporator coil and a compressor in the existing cooling system. The thermal energy storage unit is configured to form a thermosyphon with the evaporator coil.

The foregoing summary is provided as a simplified introduction to the disclosure, and is not intended to be used to limit the scope of the appended claims.

### BRIEF DESCRIPTION OF THE DRAWINGS

With reference to the following description and accompanying drawings:

FIG. 1 illustrates an exemplary cooling system in an energy consumption mode according to various embodiments;

FIG. 2 illustrates an exemplary cooling system in an energy storage mode according to various embodiments;

FIG. 3 illustrates an exemplary cooling system in an energy discharge mode according to various embodiments;

FIG. 4 illustrates an exemplary thermal energy storage unit according to various embodiments;

FIG. 5 illustrates a top view of an exemplary thermal energy storage unit according to various embodiments;

FIG. 6 illustrates an exemplary thermal energy storage system having a primary tank and two secondary tanks according to various embodiments;

FIG. 7 illustrates a block diagram of an exemplary rotary valve apparatus according to various embodiments;

FIG. 8 illustrates a side view of an exemplary rotary valve apparatus according to various embodiments; and

FIGS. 9-11 illustrate section views of an exemplary rotary valve apparatus according to various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the present disclosure.

In accordance with principles of the present disclosure, thermal energy systems may store energy for use at a later time. For example, ice may be generated in a thermal energy storage unit, and the ice may later be used to cool a refrigerant which provides cooling, for example to a residential air-conditioning system. The ice may be formed during periods of low energy demand, and the stored thermal energy may be discharged during periods of high energy demand. One or more valves, for example 3-way valves, may direct refrigerant through a compressor to store energy or provide cooling during periods of low energy demand, and the valves may be switched to direct refrigerant from the thermal energy storage unit to an evaporator coil during periods of high energy demand to provide cooling, for example to a residence.

In various exemplary embodiments, a thermal energy storage unit may be coupled to the evaporator coil in a thermosyphon. As refrigerant cools in the thermal energy storage unit, the refrigerant may become more dense, and gravity may pull the denser refrigerant downward through the thermal energy storage unit. The refrigerant may flow to the evaporator coil. As the refrigerant warms or evaporates in the evaporator coil, the refrigerant may become less dense, and the less dense refrigerant may flow upwards and back to the thermal energy storage unit. Thus, the refrigerant may flow between the thermal energy storage unit and the evaporator coil without use of a pump. A fan may direct air through the evaporator coil to provide cooled air to the residence.

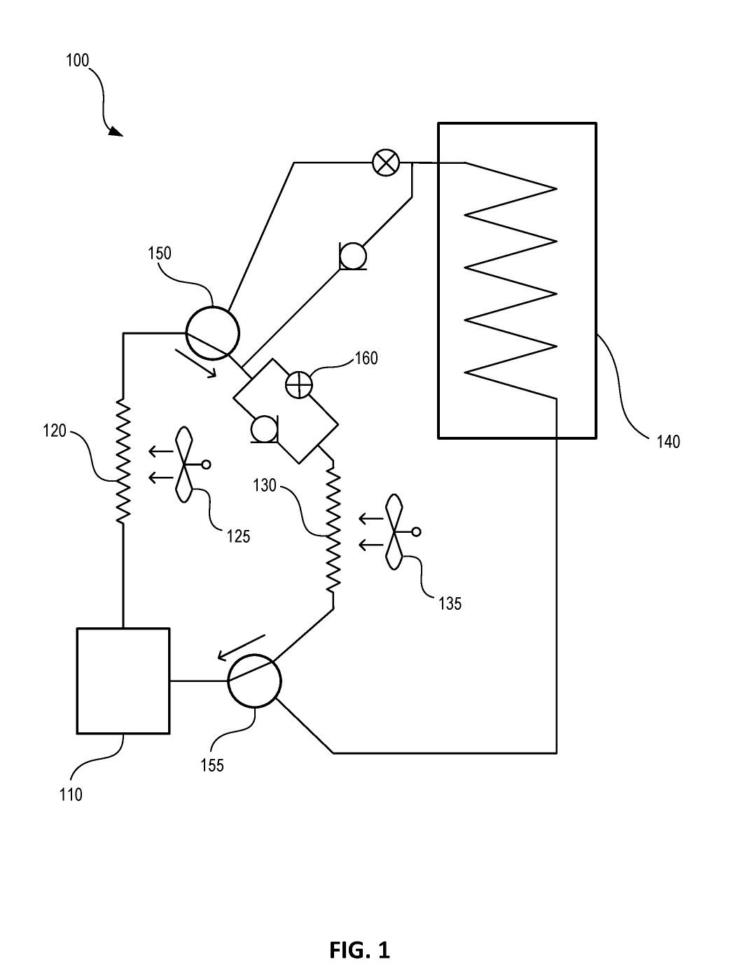

Referring now to FIG. 1, a cooling system 100 is illustrated in energy consumption mode according to various embodiments. Cooling system 100 may comprise a compressor 110, a condenser coil 120, an evaporator coil 130, and a thermal energy storage unit (“TES”) 140. During energy consumption mode, compressor 110 may compress a gas refrigerant in cooling system 100. The refrigerant may flow through condenser coil 120 and condense into a liquid. A condenser fan 125 may blow air through condenser coil 120 to partially cool the refrigerant. As the refrigerant condenses in condenser coil 120, a temperature of the refrigerant may decrease. A first 3-way valve 150 positioned between condenser coil 120 and evaporator coil 130 may direct the refrigerant to evaporator coil 130. The condensed and pressurized liquid refrigerant is next routed through an expansion valve 160 where it undergoes an abrupt reduction in pressure. The pressure reduction results in flash evaporation of a portion of the liquid refrigerant, lowering its temperature. The cold refrigerant is then routed through evaporator coil 130. The refrigerant may flow through evaporator coil 130 and evaporate into a gas. An evaporator fan 135 may blow air through evaporator coil 130 to provide chilled air to a residence. A second 3-way valve 155 positioned between evaporator coil 130 and compressor 110 may direct the refrigerant back to compressor 110.

In various embodiments, in cooling system 100 the direction of flow of the refrigerant may be reversed, for example in order to provide heating to a residence. In such cases, a second 3-way valve 155 directs refrigerant from compressor 110 to evaporator coil 130, and first 3-way valve 150 directs refrigerant from evaporator coil 130 through condenser coil 120 and to compressor 110. During heating, condenser coil 120 may act as an evaporator coil, and evaporator coil 130 may act as a condenser coil.

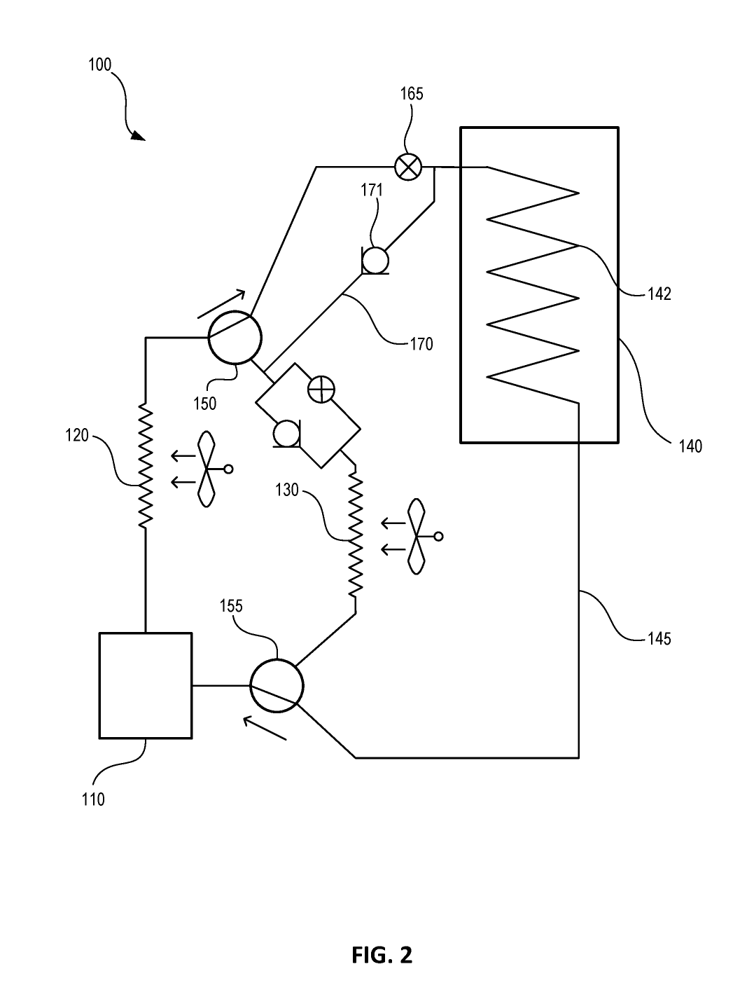

Referring now to FIG. 2, cooling system 100 is illustrated in energy storage mode according to various embodiments. During operating of cooling system 100 in an energy storage mode, first 3-way valve 150 may direct the refrigerant from condenser coil 120 to TES 140. The condensed and pressurized liquid refrigerant is routed through an expansion valve 165 where it undergoes an abrupt reduction in pressure. The pressure reduction results in flash evaporation of a portion of the liquid refrigerant, lowering its temperature. A check valve 171 in a vapor return line 170 may prevent refrigerant from flowing into evaporator coil 130 through vapor return line 170. The cooled refrigerant may flow through a cooling coil 142 in TES 140. Cooling coil 142 may chill an energy storage medium located within TES 140. For example, the energy storage medium may comprise water, a brine solution, or other suitable energy storage medium. As the refrigerant flows through cooling coil 142, heat may be transferred from the energy storage medium to the refrigerant via cooling coil 142. As heat is transferred from the energy storage medium to the refrigerant, the temperature of the energy storage medium may decrease. In various embodiments, the energy storage medium may freeze within TES 140. This heat transfer may cause the temperature of the refrigerant in cooling coil 142 to increase. The refrigerant may exit TES 140 via a TES return line 145. TES return line 145 may return the refrigerant to second 3-way valve 155. Second 3-way valve 155 may direct the refrigerant back to compressor 110. The refrigerant may continue to flow in a loop from compressor 110, through condenser coil 120, through TES 140, and back to compressor 110, in order to chill the energy storage medium and thus store thermal energy in TES 140.

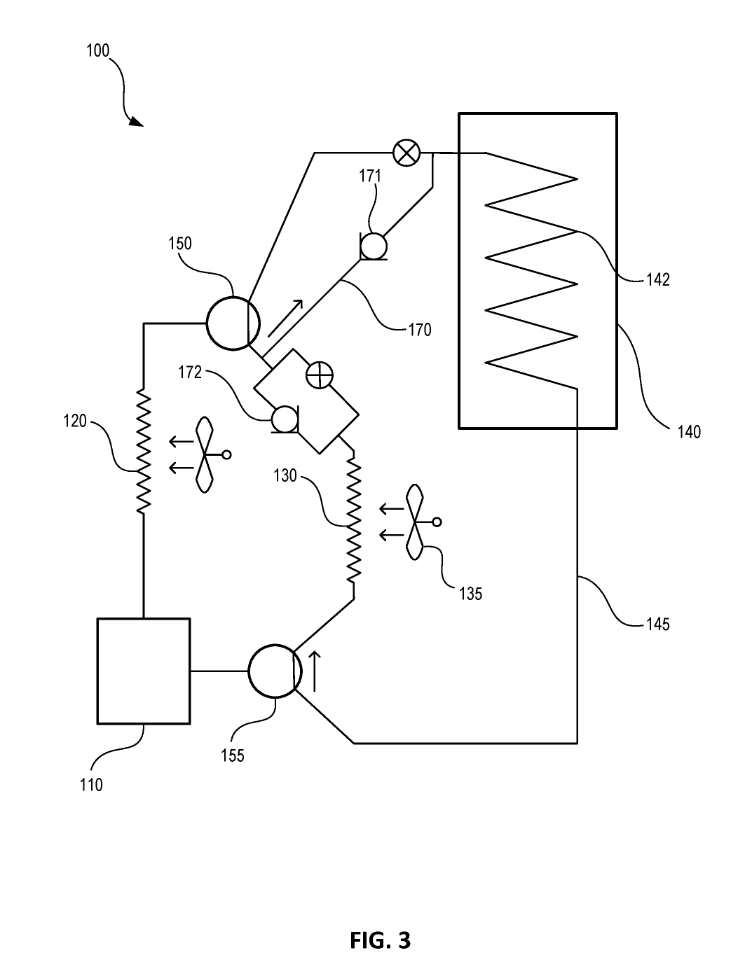

Referring now to FIG. 3, cooling system 100 is illustrated in an energy discharge mode according to various embodiments. In an energy discharge mode, second 3-way valve 155 directs refrigerant in TES return line 145 from TES 140 to evaporator coil 130, bypassing compressor 110 and condenser coil 120. In various embodiments, first 3-way valve 150 may direct refrigerant from evaporator coil 130 to TES 140. However, in various embodiments, all (or a majority of) the refrigerant exiting evaporator coil 130 may flow through a vapor line 170 to TES 140. Thus, compressor 110 and condenser coil 120 may not be used during an energy discharge mode. The cooled refrigerant from TES 140 evaporates in evaporator coil 130. Evaporator fan 135 may blow air through evaporator coil 130, for example to provide chilled air to a residence. The gas refrigerant may return to TES 140 via vapor line 170 and through check valves 172, 171. The refrigerant may flow through cooling coil 142, and the energy storage medium in TES 140 may cool the refrigerant. The cooled refrigerant may be returned to evaporator coil 130 for additional cooling of the residence. The refrigerant may continue to flow through the loop between TES 140 and evaporator coil 130, for example until the energy stored in TES 140 is fully discharged, or until no additional cooling is desired.

In various embodiments, TES return line 145 may exit TES 140 at a location with higher gravitational potential energy than a location of evaporator coil 130. Thus, the refrigerant in TES return line 145 may flow to evaporator coil 130 without use of an additional pump. The less dense refrigerant exiting evaporator coil 130 may also return to TES 140 without use of a pump. Thus, TES 140 and evaporator coil 130 may together form a thermosyphon, in which refrigerant is transferred between TES 140 and evaporator coil 130 without use of a pump.

In accordance with principles of the present disclosure, a thermosyphon configuration may allow circulation of refrigerant without the necessity of a mechanical pump. As the refrigerant is heated and evaporates, the refrigerant becomes less dense, and thus more buoyant than the cooler refrigerant. Convection moves the less dense refrigerant upwards in the system as it is replaced by cooler refrigerant returning from TES 140 by gravitational force. Thus, in an energy discharge mode, evaporator fan 135 may be the only component of cooling system 100 which utilizes electricity. This may result in decreased energy consumption during the energy discharge mode, for example in comparison to systems which use a pump to circulate refrigerant.

In various exemplary embodiments, the amount of cooling provided to a residence during energy discharge mode operation of cooling system 100 may be controlled by controlling operation of evaporator fan 135. Increasing power to evaporator fan 135 may increase the rate of evaporation of the refrigerant and thus increase the rate of circulation of the refrigerant. However, in various embodiments, a throttle valve may be inserted in vapor line 170 or TES return line 145 in order to control the rate of circulation of refrigerant. Moreover, any suitable control scheme or components to direct operation of evaporator fan 135 may be utilized, as desired.

In various embodiments, TES 140 may be retrofitted and/or retrofittable into an existing cooling system. An existing cooling system may comprise a compressor 110, a condenser coil 120, and an evaporator coil 130. In order to retrofit the existing cooling system, a first 3-way valve 150 may be installed, for example between condenser coil 120 and evaporator coil 130. A second 3-way valve 155 may be installed, for example between evaporator coil 130 and compressor 110. TES 140 may be connected to the first 3-way valve 150 and the second 3-way valve 155, and vapor line 170 may connect TES 140 to evaporator coil 130. Thus, in accordance with principles of the present disclosure, existing cooling systems may be retrofitted with only minor modifications in order to integrate with exemplary thermal energy storage systems and use a thermosyphon to cycle refrigerant.

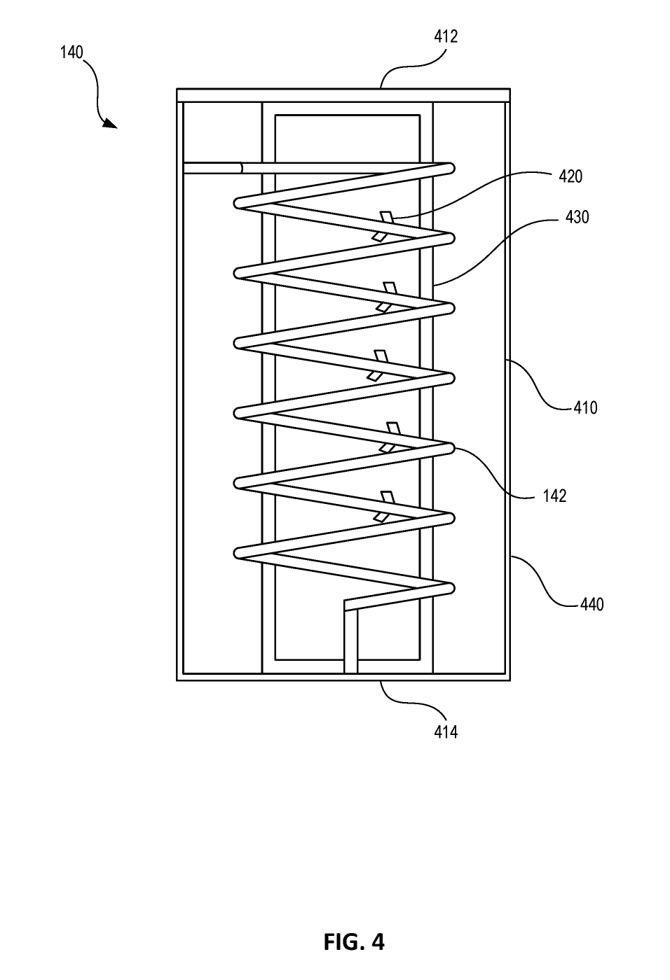

Referring now to FIG. 4, TES 140 is illustrated according to various embodiments. TES 140 may comprise a tank 410. Tank 410 may comprise any type of receptacle capable of containing a liquid. For example, in various embodiments, tank 410 may comprise a cylindrical barrel, a rectangular box, or any other suitable receptacle. In various embodiments, tank 410 may be insulated, such as with multi-panel walls, or with an exterior insulation 440 coupled to tank 410.

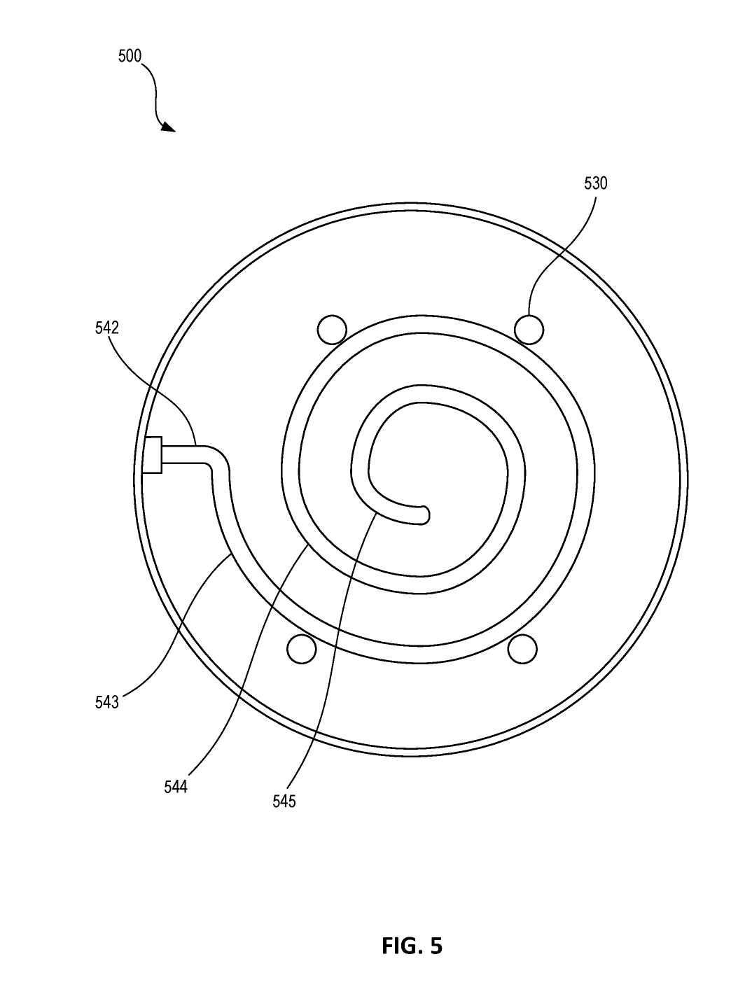

A cooling coil 142 may be located within tank 410. In various embodiments, cooling coil 142 may be formed from copper refrigerant tubing. The cooling coil 142 may be configured with a constant downward slope, such that no traps form which may deprive the compressor of oil. In various embodiments, cooling coil 142 may comprise a single helical coil extending from top 412 of tank 410 to bottom 414 of tank 410. However, cooling coil 142 may comprise a variety of shapes, including a spiral coil as described with reference to FIG. 5. The shape of cooling coil 142 may be selected such that ice forms generally in a center of tank 410 while leaving a liquid layer at the walls of tank 410, for example in order to avoid outward pressure on the tank walls which may damage tank 410.

A plurality of fins 420 may be coupled to cooling coil 142. The fins 420 may comprise a piece of copper sheet or other suitable thermally conductive material. Fins 420 may provide additional surface area which may aid in heat transfer between cooling coil 142 and the thermal storage medium within tank 410.

In various embodiments, TES 140 may comprise an internal frame 430 to provide structural integrity and/or support to TES 140 and/or components therein. Internal frame 430 may be preloaded against top 412 of tank 410. Moreover, cooling coil 142 may be coupled to internal frame 430. Cooling coil 142 may be subjected to a buoyancy force from the thermal storage medium. However, coupling cooling coil 142 to internal frame 430 may prevent movement of cooling coil 142 within tank 410.

Referring now to FIG. 5, TES 500 is illustrated according to various embodiments. In TES 500, a cooling coil 542 may be configured as a spiral coil. To form cooling coil 542, a copper refrigerant tubing may be formed around a tool designed to provide coil loops of decreasing diameters. For example, a first coil loop 543 may be configured with roughly a 16 inch diameter, a second coil loop 544 may be configured with roughly a 10 inch diameter, and a third coil loop 545 may be configured with roughly a 4 inch diameter. However, in various embodiments, any suitable diameters or rates of coil diameter reduction may be used for the coil loops. Additionally, a plurality of spiral coils may be coupled together and distributed within TES 500. The spiral coils may be coupled to internal frame 530 in order to prevent displacement of the cooling coils.

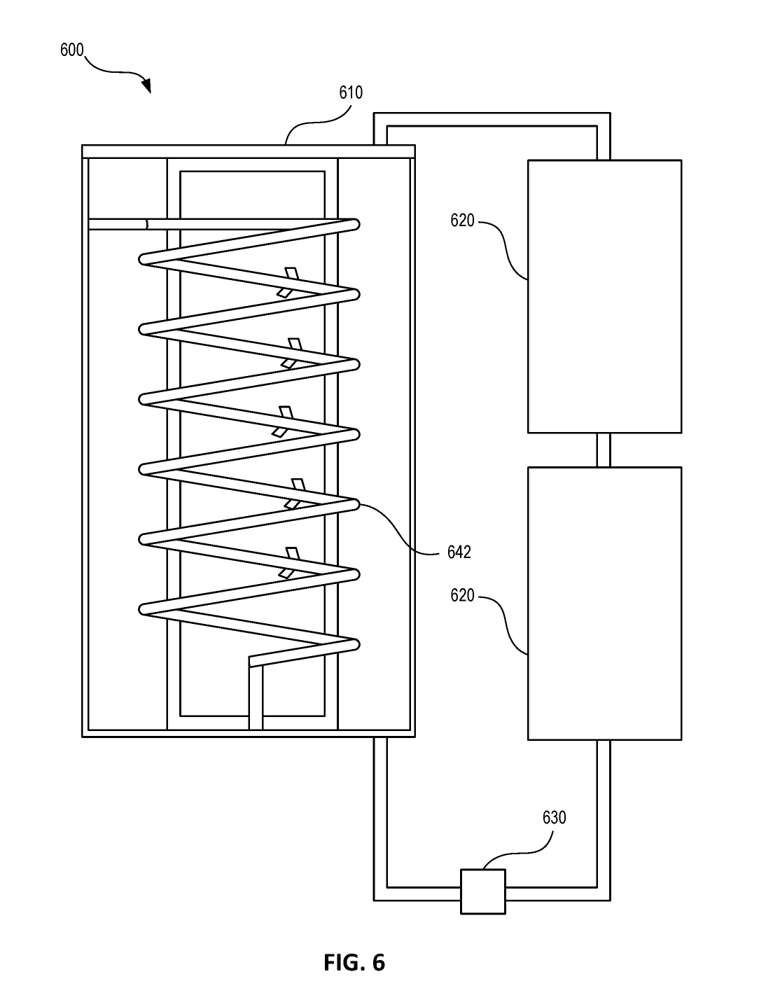

Referring now to FIG. 6, in various exemplary embodiments a TES 600 is configured with at least one secondary storage tank, for example two secondary storage tanks 620. TES 600 may comprise a primary tank 610 and one or more secondary storage tanks 620. A pump, for example brine pump 630, may pump the energy storage medium from primary tank 610 through secondary storage tanks 620 and back to primary tank 610. Secondary storage tanks 620 may provide additional storage capability to TES 600. Brine pump 630 may circulate the energy storage medium during charging of TES 600, storing additional thermal energy in secondary storage tanks 620. During discharge of TES 600, brine pump 630 may circulate the energy storage medium through secondary storage tanks 620 and primary tank 610 to provide additional stored thermal energy to TES 600, which may be used to cool the refrigerant flowing through cooling coil 642 in primary tank 610.

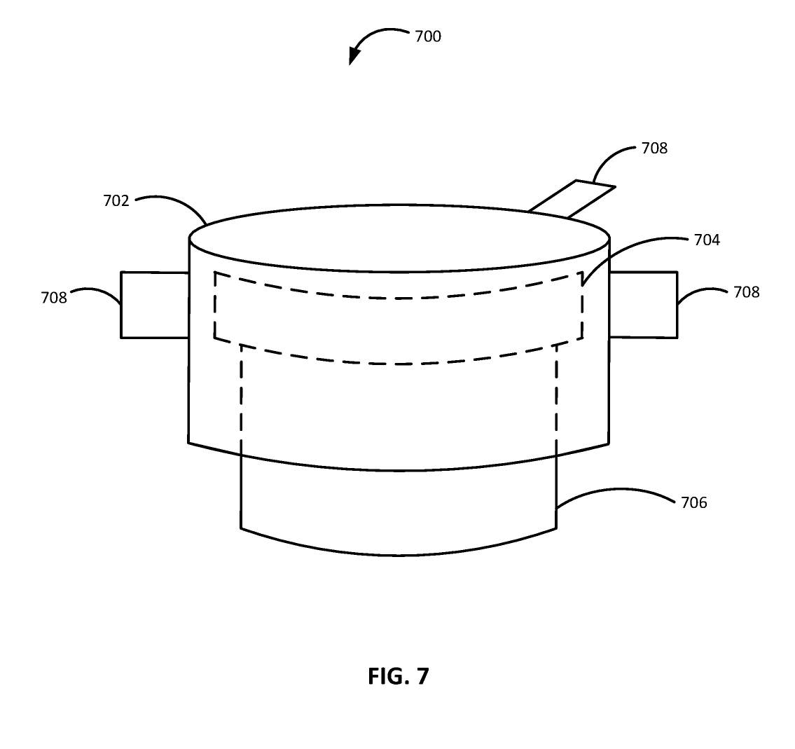

Referring now to FIGS. 1 and 7, in various embodiments, the first 3-way valve 150 may comprise a rotary valve apparatus 700, and second 3-way valve 155 may comprise a rotary valve apparatus 700. The first 3-way valve 150 and the second 3-way valve 155 may be configured to be similarly sized, similarly constructed, and or similarly operational; moreover, the first 3-way valve 150 and the second 3-way valve 155 may differ from one another, for example in size, materials, and/or the like, in order to achieve one or more desired operational characteristics of the cooling system 100.

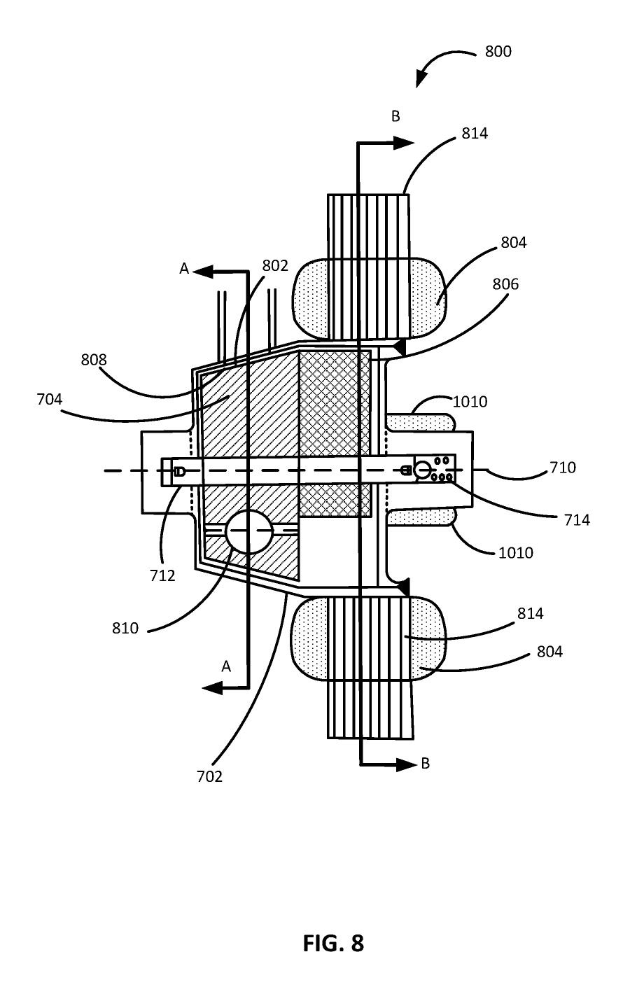

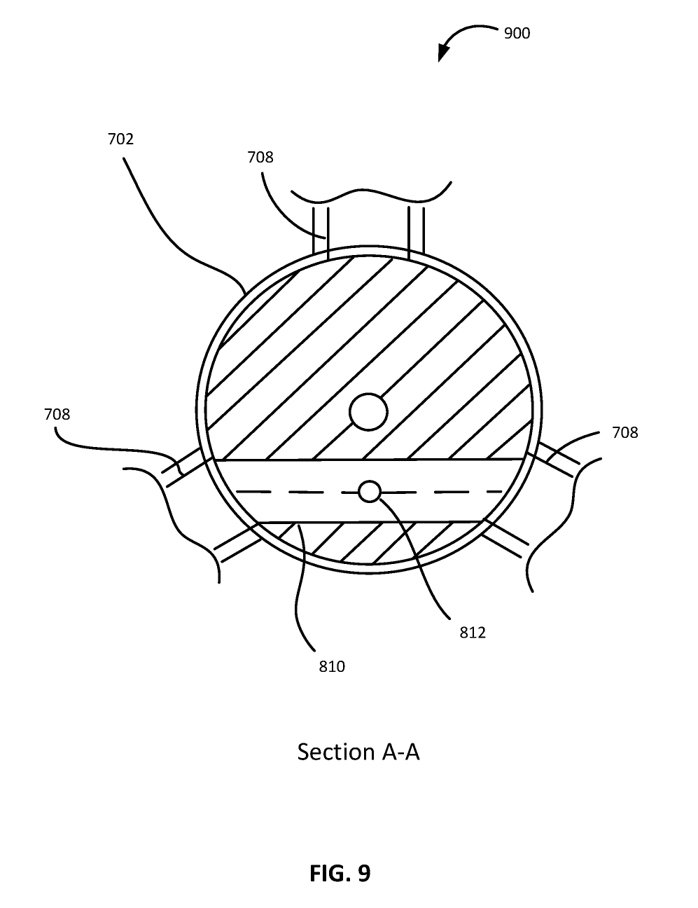

In various embodiments, a rotary valve apparatus 700 comprises a case 702, a fluid conducting apparatus 704, an electromechanical actuator 706, and a plurality of fluid ports 708. In various embodiments, a rotary valve apparatus 700 further comprises a balance port 812 (as illustrated in FIG. 9) and a solenoid coil 1010 (as illustrated in FIG. 8), as further discussed herein below.

Referring to FIGS. 7-9, case 702 may comprise a plurality of fluid ports 708, for example disposed circumferentially about the perimeter of the case 702. In one example embodiment, three ports are arranged about the case 702. In one example embodiment, these ports are disposed at about 120 degrees from each other, though any position suitably configured to interface with refrigerant lines may be utilized. In one example embodiment, the ports are configured as ¼″ NPT, and the portion of the body about which the ports are disposed has a diameter of about 1.700″, though any dimension configured to permit the fluid ports 708 to connect in fluid communication with the fluid conducting apparatus 704 may be adopted.

Furthermore, rotary valve apparatus 700 may be a two position valve, or a four position valve, or a valve having any number of positions adaptably configured to interconnect any number of components with a fluid system. As such, in accordance with principles of the present disclosure, a rotary valve apparatus 700 may have two ports, or four ports, or may have any number of ports arranged about the case in any pattern adapted to interconnect components with a fluid system.

In one example embodiment, case 702 is hermetically sealed. Case 702 may comprise 700 series stainless steel and be welded together to make a hermetically sealed unit. In another example embodiment, 2″ diameter 6061-T6 bar stock may be chosen for case 702, though any metal, ceramic, alloy, composite, or other material suitable for forming case 702 may be utilized. In one example embodiment, a pair of SAE #220 Nitrile rubber O-rings may be utilized to seal portions of a case 702, though any O-ring or other sealing mechanism or component that results in an acceptable seal may be utilized. In one example embodiment, case 702 has an inner diameter of about 1.625″, though any diameter suitable for use in conjunction with a chosen O-ring and acceptable case fatigue life may be utilized. Still further, one example embodiment may also comprise an internal snap ring, for example having a size of between about 1.5″ and about 2″, and preferably about 1.75″. It will be appreciated that the foregoing dimensions and configuration for case 702 are given by way of example, and not of limitation.

Referring now to FIGS. 8 and 9, case 702 may be configured with a cylindrical housing. In various embodiments, case 702 may further comprise a conic section. However, case 702 may comprise any shape, geometry, or structure of housing configured to retain a fluid conducting apparatus 704. In various embodiments, case 702 further comprises three fluid ports 708, and a first locking surface 802. First locking surface 802 may comprise an internal face of case 702 configured to interface with fluid conducting apparatus 704 (for example, a second locking surface 808 of fluid conducting apparatus 704).

In various embodiments, fluid conducting apparatus 704 is disposed within case 702. Fluid conducting apparatus 704 may be movable in response to operation of electromechanical actuator 706. In various embodiments, fluid conducting apparatus 704 is axially rotatable about an axis 710 passing through the center of case 702. Fluid conducting apparatus 704 may be moved in response to operation of electromechanical actuator 706 and may connect various fluid ports 708, for example in pairs.

In various embodiments, fluid conducting apparatus 704 comprises a second locking surface and a first transfer passage. For example, fluid conducting apparatus 704 may comprise second locking surface 808. Second locking surface 808 may comprise a surface of fluid conducting apparatus 704 configured to interface with first locking surface 802 of case 702. In this manner, first locking surface 802 may comprise a face of a conic portion of case 702, and second locking surface 808 may comprise a face of a conic portion of fluid conducting apparatus 704. In various embodiments, first locking surface 802 and second locking surface 808 may comprise a face of a differently shaped portion of a case 702 and fluid conducting apparatus 704, respectively. Moreover, first locking surface 802 and second locking surface 808 may comprise faces having any shapes, coatings, roughness, or texturing suitable for holding the fluid conducting apparatus 704 in substantially fixed rotational position, for example, to prevent the fluid conducting apparatus 704 from inadvertent movement or rotation, while still also permitting desired movement or rotation.

In various embodiments, fluid conducting apparatus 704 comprises a first transfer passage 810. First transfer passage 810 may comprise a hollow aperture substantially aligned with a chord of fluid conducting apparatus 704. However, first transfer passage 810 may comprise any aperture, pathway, tunnel, tube, or conduit having any orientation such that first transfer passage 810 may be oriented to connect two fluid ports 708.

With reference now to FIGS. 7-11, in various embodiments, rotary valve apparatus 700 comprises an electromechanical actuator 706. An electromechanical actuator 706 may comprise a reluctance actuator 804 and a magnetic rotor 806. In various embodiments, reluctance actuator 804 may generate an electromagnetic field whereby a motive force may be exerted on magnetic rotor 806. For example, in various embodiments a reluctance actuator 804 may comprise at least one coil of wire which generates an electromagnetic field when energized. In various embodiments, magnetic rotor 806 comprises a semicircular body comprising a ferromagnetic material. However, any suitable shape for magnetic rotor 806 may be utilized. In various embodiments, magnetic rotor 806 is attached to fluid conducting apparatus 704. Thus, reluctance actuator 804 may exert a motive force on magnetic rotor 806 whereby fluid conducting apparatus 704 may be translated along axis 710 and/or rotated about axis 710. In this manner, fluid conducting apparatus 704 may be selectively moved so that the fluid transfer passage 810 selectively connects different fluid ports 708.

In various embodiments, a reluctance actuator 804 comprises a first coil pair 1001, a second coil pair 1003, and a third coil pair 1007. Each coil pair may be positioned at least partially around the circumference of case 702, such that each coil pair, when energized, impels fluid conducting apparatus 704 to be selectively moved to connect a different pair of fluid ports 708, in accordance with the principles disclosed herein.

Moreover, in various embodiments, each coil pair comprises a clockwise stator coil and a counterclockwise stator coil. For example, first coil pair 1001 may comprise a clockwise stator coil 1002 and a counterclockwise stator coil 1004. Second coil pair 1003 may comprise a clockwise stator coil 1005 and a counterclockwise stator coil 1006. Third coil pair 1007 may comprise a clockwise stator coil 1008 and a counterclockwise stator coil 1009. A clockwise stator coil may comprise a wound coil of wire having the wire wound in an opposite direction compared to a counterclockwise stator coil. In this manner, and in accordance with the right-hand rule, a clockwise stator coil and the corresponding counterclockwise stator coil may generate magnetic lines of force operating in opposite directions. Thus, a north magnetic pole and a south magnetic pole may be established for each coil pair. In various embodiments, by selectively energizing different coil pairs, magnetic rotor 806 may be moved to different orientations coinciding with the different coil pairs. In various example embodiments, coils of 250 turns of 28 gauge magnet wire potted in epoxy may be used. Moreover, any suitable number of turns and any suitable gauge of wire may be utilized in order to ensure reliable operation of reluctance actuator 804.

In one example embodiment, the windings alternate between clockwise (CW) and counter-clockwise (CCW) windings so that each position has a north magnetic pole, and a south magnetic pole, though any winding configuration adapted to cause the valve to rotate when actuated may be implemented. In one example embodiment, reluctance actuator 804 comprises three pairs of windings, though any number of windings or pairs of windings may be utilized to permit the valve to interface with a particular number and arrangement of ports.

Furthermore, in one example embodiment, the windings are wired in a Y configuration, with the common leg going through an optional coil to produce rotor thrust. Thus, a rotary valve apparatus 700 may comprise a solenoid coil 1010. Solenoid coil 1010 may be configured to help lift fluid conducting apparatus 704 to disengage second locking surface 808 from first locking surface 802, for example in order to reduce the torque needed to move and/or rotate fluid conducting apparatus 704. In other example embodiments, solenoid coil 1010 may be omitted. For example, solenoid coil 1010 may be omitted if the coil pairs are installed with a sufficiently high elevation so as to lift the fluid conducting apparatus 704 without a solenoid coil 1010.

In various embodiments, reluctance actuator 804 further comprises a lamination stack 814. In one example embodiment, the lamination stack 814 may comprise 26 layers of a six pole laminate of 0.018″ thick M-19 electrical steel. However, any suitable lamination architecture configured to operate the rotary valve apparatus 700 at a desired operational voltage and current and with desired operational characteristics may be implemented. In various embodiments of rotary valve apparatus 700, the coils fit into slots of the lamination stack 814 of reluctance actuator 804. In one embodiment, the laminate design has about a 1.700″ diameter bore with the pole width generally equal to the space in between poles. It will be appreciated that the foregoing dimensions and sizes are given by way of example and illustration, and not of limitation.

Referring now to FIGS. 8, 10, and 11, in various embodiments, a magnetic rotor 806 may comprise a semicircular body comprising a ferromagnetic material. In various embodiments, magnetic rotor 806 is attached to fluid conducting apparatus 704. Thus, when magnetic rotor 806 is translated or rotated in response to selectively energizing different coil pairs of reluctance actuator 804, fluid conducting apparatus 704 is similarly translated and/or rotated. The semicircular body of magnetic rotor 806 may have an arc length of sufficient length relative to (i) the circumference of case 702 and (ii) the positioning of the stator coil pairs, such that by energizing an adjacent coil pair, the magnetic rotor 806 may be moved from an orientation corresponding with one coil pair, to an orientation corresponding with the adjacent coil pair. For example, magnetic rotor 806 may be positioned corresponding with first coil pair 1001. In various embodiments, by energizing the third coil pair 1007, magnetic rotor 806 may be influenced to reorient corresponding with the third coil pair 1007. Alternatively, by energizing the second coil pair 1003, magnetic rotor 806 may be influenced to move to a position corresponding with the second coil pair 1003. In this manner, a magnetic rotor 806 oriented corresponding to any stator coil pair may be influenced to move to a position corresponding with another stator coil pair by energizing the stator coil pair corresponding to the desired position.

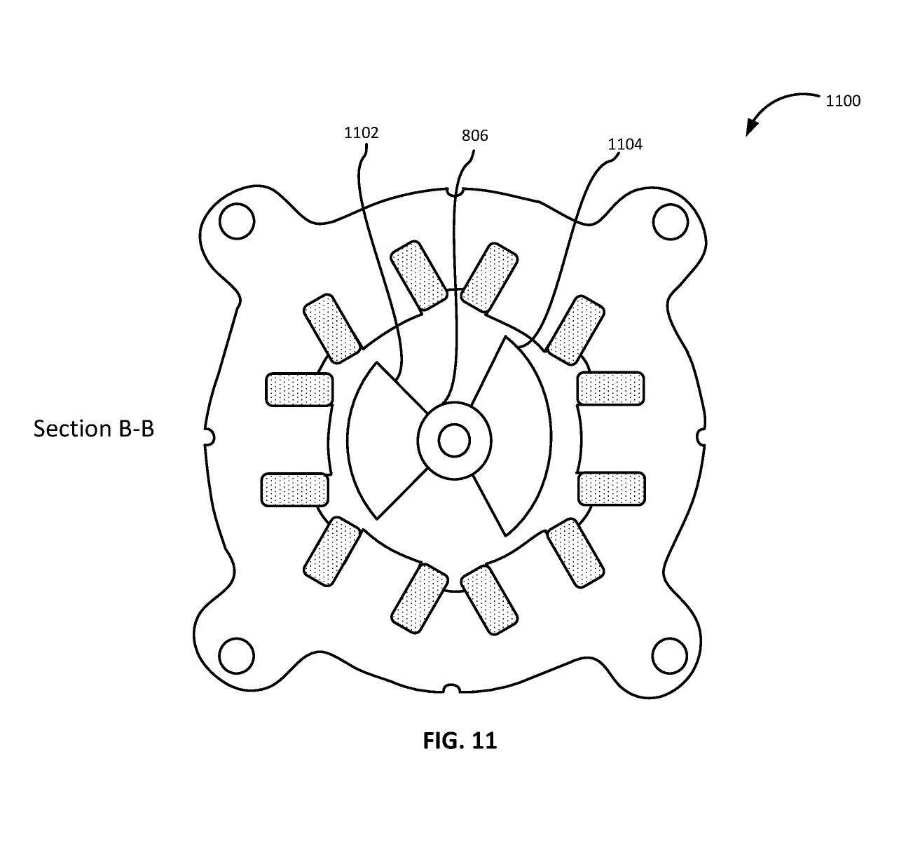

In various embodiments, magnetic rotor 806 comprises a plurality of semicircular sections. For example, referring again to FIG. 11, in various embodiments, magnetic rotor 806 comprises a magnetically influenced section 1104 and a counterweight section 1102. In this manner, the balance of the magnetic rotor 806 may be improved. In various embodiments, magnetically influenced section 1104 comprises a highly ferromagnetic material, for example iron, steel, and/or the like. In various embodiments, counterweight section 1102 comprises a material less ferromagnetic than magnetically influenced section 1104, for example copper, brass, and/or the like.

In various embodiments, magnetically influenced section 1104 and counterweight section 1102 are configured with different sizes. For example, counterweight section 1102 may be sized so as to be less able to be stably oriented by reluctance actuator 804, whereas magnetically influenced section 1104 may be sized so as to acquiesce to a stable orientation when influenced by reluctance actuator 804. In this manner, the magnetic rotor 806 may have a single stable orientation corresponding to each stator coil pair.

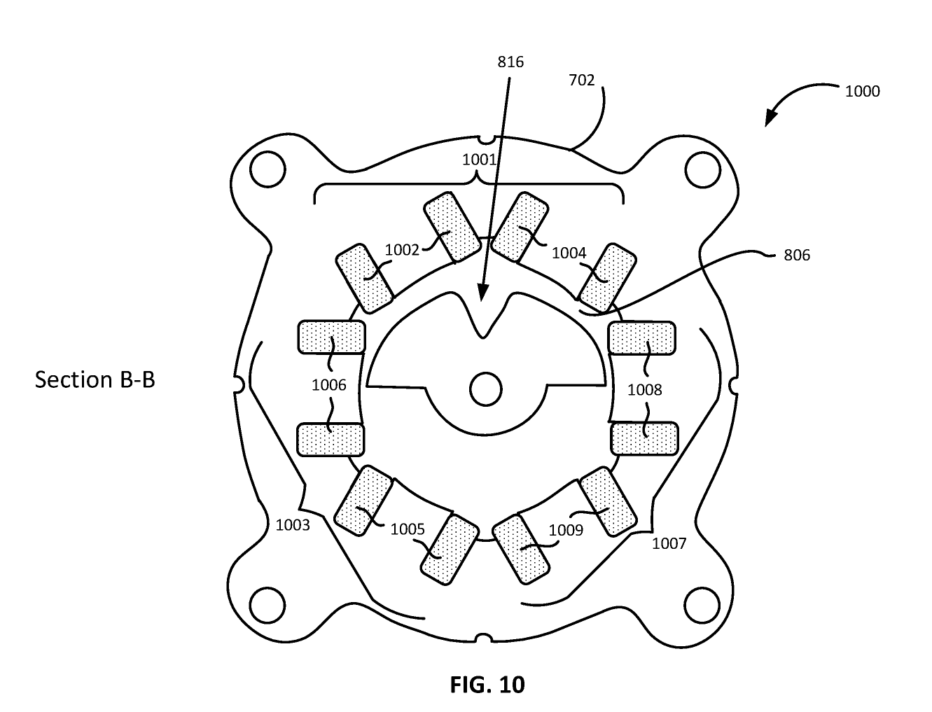

In various embodiments, rotary valve apparatus 700 utilizes external power only during movement from a first (i.e., original) position to a second (i.e., new) position. With reference to FIG. 10, in one example embodiment, magnetic rotor 806 is configured with a notch 816. Notch 816 may be disposed in the center along the arc length of the magnetic rotor 806. Moreover, notch 816 may be located in any suitable location such that magnetic rotor 806 is configured to increase the restoring torque versus misalignment curve slope. Moreover, magnetic rotor 806 may be sized, shaped, and/or configured with any suitable components or arrangements such that magnetic rotor 806 is configured to increase the restoring torque versus misalignment curve slope. In one example embodiment, notch 816 is off-center so that magnetic rotor 806 is sufficiently proximate to adjacent coil pairs to provide initial torque and lift to start movement of magnetic rotor 806 to a new position.

In certain embodiments, magnetic rotor 806 may comprise a polyimide plastic and have two sections of about 120 degrees. Referring to FIG. 11, in various embodiments, these sections comprise a magnetically influenced section 1104 and a counterweight section 1102. For example, counterweight section 1102 may be made of copper and magnetically influenced section 1104 may be made of mild steel, though any configuration adapted to permit magnetic rotor 806 to function may be utilized. Furthermore, the height of the steel sector may be about 0.5″, and the height of the copper sector may be reduced below the height of the steel sector, for example, to make the copper sector weigh about the same as the steel sector. Moreover, it will be appreciated that any configuration yielding appropriate balance may be implemented.

In one example embodiment, the sectors of magnetic rotor 806 are not both 120 degree sections, but differ from one another, for example in arc length, height, thickness, material, and/or the like. In one example embodiment, the magnetic rotor copper sector may be drilled and countersunk to accept a fastener, for example a 1.5″ long brass 8-32 flat head screw, and the steel sector may be drilled and tapped with an 8-32 thread. An 8-32 screw may then be implemented to join the magnetic rotor sectors. However, any suitable method or components for coupling portions of magnetic rotor 806 may be utilized, as desired.

Referring now to FIG. 9, in various embodiments, rotary valve apparatus 700 further comprises a balance port 812. For example, balance port 812 may be configured as an aperture through case 702 through which tools may be inserted to remove (e.g., drill out) material from fluid conducting apparatus 704 and/or magnetic rotor 806. In this manner, the balance of the various components of the rotary valve apparatus 700 may be fine-tuned, as desired.

Referring back to FIG. 8, in various embodiments, rotary valve apparatus 700 further comprises a solenoid coil 1010. For example, in some embodiments, reluctance actuator 804 is oriented so as to exert insufficient lift force to disengage second locking surface 808 from first locking surface 802. Thus, in some embodiments, solenoid coil 1010 is implemented to provide lift force to disengage the locking surfaces prior to rotation of the magnetic rotor 806 to correspond to a stator coil pair of the reluctance actuator 804.

In various embodiments, case 702 further comprises an axis shaft 712. Axis shaft 712 lies coincident with axis 710. In various embodiments, fluid conducting apparatus 704 is supported by axis shaft 712 and rotates axially about axis shaft 712. In various embodiments, axis shaft 712 connects to fluid conducting apparatus 704 and magnetic rotor 806. As a result, axis shaft 712 may rotate and translate in unison with fluid conducting apparatus 704 and magnetic rotor 806. Axis shaft 712 may be supported at one end, for example by a spring assembly 714. Spring assembly 714 is configured to impel axis shaft 712, and correspondingly fluid conducting apparatus 704, toward the first locking surface 802 of case 702. Thus, spring assembly 714 may exert a seating force, seating second locking surface 808 against first locking surface 802. In various embodiments, solenoid coil 1010 may be positioned to exert a force on magnetic rotor 806 in a direction opposite of spring assembly 714. In this manner, solenoid coil 1010 may assist the disengagement and/or engagement of second locking surface 808 with first locking surface 802.

Axis shaft 712 may comprise any suitable material configured to permit the rotary valve apparatus 700 to actuate, for example music wire having a diameter of between about 0.8 mm and about 1.2 mm. In one embodiment, jewel bearings support certain moving components of a rotary valve apparatus 700. The jewel bearings may comprise hematite cylindrical beads and/or the like, although any bushing, bearing, or material chosen for acceptable frictional characteristics may be used.

Furthermore, axis shaft 712 may optionally be omitted, or alternatively, may be used to increase the axial forces during actuation and/or to increase the axial forces at rest, and/or to reduce the drag torque during actuation, and/or to increase the holding torque during rest. Axis shaft 712 and/or magnetic rotor 806 may be configured, responsive to operation of solenoid coil 1010, to produce a high initial lift force to free fluid conducting apparatus 704 from case 702.

In accordance with the principles of the present disclosure, rotary valve apparatus 700 may be positioned so that axis 710 is vertical and reluctance actuator 804 is positioned above magnetic rotor 806. Thus, at rest, second locking surface 808 of fluid conducting apparatus 704 rests on first locking surface 802 of case 702. When a pair of coils is powered, fluid conducting apparatus 704 is lifted free of first locking surface 802 and pivots to align with the powered coil pair. When power is removed, fluid conducting apparatus 704 may drop onto first locking surface 802 of case 702 and may be held in place by gravity, for example, on first locking surface 802. Thus, for example, in one embodiment, rotary valve apparatus 700 may only require a small amount of power to change position, and no power during use.

In accordance with the principles of the present disclosure, when a pair of coils is powered, magnetic rotor 806 may move, for example, in a 120 degree increment, or any other increment selected to position fluid transfer passage 810 of fluid conducting apparatus 704 to connect at least two fluid ports 708. In one example embodiment, the coils may be powered by a 12V DC 1 Amp class II transformer with a 0.065 Farad capacitor, though any suitable voltage and/or current source may be utilized. The capacitor may be selected with consideration for the frequency of actuation and actuation force, so the actuator has the greatest magnetic force at just the moment it needs to be operable to lift and pull in the steel sector from an adjacent position.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled”, “coupling” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A cooling system comprising:
a compressor;
a condenser coil;
an evaporator coil;
a thermal energy storage unit;
a first 3-way valve positioned between the condenser coil and the evaporator coil; and
a second 3-way valve positioned between the evaporator coil and the compressor;
wherein the thermal energy storage unit and the evaporator coil form a thermosyphon.

2. The cooling system of claim 1, further comprising a vapor line connecting the evaporator coil to the thermal energy storage unit.

3. The cooling system of claim 1, wherein in an energy consumption mode, the first 3-way valve is configured to direct refrigerant from the condenser coil to the evaporator coil, and the second 3-way valve is configured to direct refrigerant from the evaporator coil to the compressor.

4. The cooling system of claim 1, wherein in an energy storage mode, the first 3-way valve is configured to direct refrigerant from the condenser coil to the thermal energy storage unit, and the second 3-way valve is configured to direct refrigerant from the thermal energy storage unit to the compressor.

5. The cooling system of claim 1, wherein in a discharge mode, the second 3-way valve is configured to direct refrigerant from the thermal energy storage unit to the evaporator coil.

6. The cooling system of claim 1, wherein an exit of the thermal energy storage unit is located at a position having higher gravitational potential energy than the evaporator coil.

7. The cooling system of claim 1, wherein during a discharge mode, the thermal energy storage unit and the evaporator coil are configured to circulate refrigerant without use of a mechanical pump.

8. The cooling system of claim 1, wherein the thermal energy storage unit comprises a primary tank and a secondary tank.

9. The cooling system of claim 8, further comprising a cooling coil within the primary tank.

10. The cooling system of claim 8, further comprising a pump configured to circulate a thermal energy storage medium between the primary tank and the secondary tank.

11. A method of providing cooling, the method comprising:
operating a cooling system in an energy consumption mode;
operating the cooling system in an energy storage mode; and
operating the cooling system in an energy discharge mode.

12. The method of claim 11, wherein operation of the cooling system in the energy consumption mode comprises:
compressing a refrigerant in a compressor;
directing the refrigerant through a condenser coil;
directing the refrigerant from the condenser coil to an evaporator coil via a first 3-way valve; and
directing the refrigerant from the evaporator coil to the compressor via a second 3-way valve.

13. The method of claim 12, wherein operation of the cooling system in the energy storage mode comprises:
compressing the refrigerant in the compressor;
directing the refrigerant through the condenser coil;
directing the refrigerant from the condenser coil to a thermal energy storage unit via the first 3-way valve; and
directing the refrigerant from the thermal energy storage unit to the compressor via the second 3-way valve.

14. The method of claim 13, wherein operation of the cooling system in the energy discharge mode comprises directing refrigerant from the thermal energy storage unit to the evaporator coil via the second 3-way valve, wherein the refrigerant returns to the thermal energy storage unit from the evaporator coil via a vapor line.

15. The method of claim 14, wherein in the energy discharge mode, the thermal energy storage unit and the evaporator coil form a thermosyphon.

16. The method of claim 15, further comprising, in the energy discharge mode, directing the refrigerant from the evaporator coil to the thermal energy storage unit via the first 3-way valve.

17. The method of claim 15, wherein in the energy discharge mode, the refrigerant circulates between the thermal energy storage unit and the evaporator coil without use of a pump.

18. The method of claim 13, wherein the thermal energy storage unit comprises a primary tank and a secondary tank.

19. The method of claim 18, further comprising circulating a thermal energy storage medium between the primary tank and a secondary tank using a pump.

20. A thermal energy storage system, comprising:
a thermal energy storage unit;
a first 3-way valve configured to be inserted between a condenser coil and an evaporator coil in an existing cooling system; and
a second 3-way valve configured to be inserted between the evaporator coil and a compressor in the existing cooling system,
wherein the thermal energy storage unit is configured to form a thermosyphon with the evaporator coil.

21. The thermal energy storage system of claim 20, further comprising a vapor line configured to connect the evaporator coil to the thermal energy storage system.

22. The thermal energy storage system of claim 20, wherein the thermal energy storage unit comprises a primary tank and a secondary tank.

23. The thermal energy storage system of claim 22, further comprising a pump configured to circulate a thermal energy storage medium between the primary tank and the secondary tank.

24. The thermal energy storage system of claim 21, wherein the thermal energy storage unit is configured to be installed at a location of higher gravitational potential energy than the evaporator coil.
